(19) United States
(12) Patent Application Publication
(10) Pub. No.: US 2008/0259235 A1
(43) Pub. Date: Oct. 23, 2008

(54) PIXEL CIRCUIT AND DRIVING METHOD THEREOF IN LIQUID CRYSTAL DISPLAY PANEL AND LIQUID CRYSTAL DISPLAY

(75) Inventors: Yao-Hong Chien, Taoyuan County (TW); Chih-Chieh Wang, Taipei County (TW); Szu-Fen Chen, Taoyuan (TW); Jung-Chieh Cheng, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/944,428

(22) Filed: Nov. 22, 2007

(30) Foreign Application Priority Data
Apr. 23, 2007 (TW) 96114215

(51) Int. Cl. G02F 1/1333

(52) U.S. Cl. 349/39

(57) ABSTRACT

A pixel circuit and a driving method thereof in a liquid crystal display (LCD) panel and an LCD are provided. One select line is added to the pixel circuit of the present invention. When the pixel circuit is in a holding state, a select signal is provided to the select line for pulling up the voltage level of the pixel electrode. Therefore, the insertion of the black frames into the images in the LCD panel and the LCD is completed by the present invention during one frame period.

### CROSS-REFERENCE TO RELATED APPLICATION

This application claims the priority benefit of Taiwan application serial no. 96114215, filed on Apr. 23, 2007. All disclosure of the Taiwan application is incorporated herein by reference.

### BACKGROUND OF THE INVENTION

1. Field of the Invention

The present invention is related to a pixel circuit and a driving method thereof which performs the insertion of the black frames into the images in a liquid crystal display (LCD) panel and an LCD. More particularly, the invention is related to a pixel circuit and a driving method thereof which does not utilize display data to transmit the black state signals so as to perform the insertion of the black frames into the images in an LCD panel and an LCD.

2. Description of Related Art

In recent years, liquid crystal displays (LCDs) have been widely adopted and have replaced the conventional cathode ray tube (CRT) displays as a mainstream among the forthcoming displays. With improvement on the semiconductor technology, the TFT-LCD has the advantages of low power consumption, slimness and compactness, high resolution, high color saturation, long life span, and so forth. Therefore, the TFT-LCD has been extensively applied in electronic products closely related to daily life, including liquid crystal screens of computers and LCD TVs.

Generally, in rapid dynamic images of the TFT-LCD, since the response speed of the liquid crystal (LC) is not fast enough (normally 1 ms-16 ms) and the backlight system adopts a holding type driving method, the persistence of vision in human eyes would cause the problem of residual image, which is the so-called motion blur phenomenon. In order to obtain the optimal display quality while the TFT-LCD is playing rapid dynamic images, the current solutions apply the black frame insertion technology so as to reduce the residual image phenomenon caused in the rapid dynamic images displayed by the TFT-LCD.

FIGS. 1A and 1B illustrate schematic views of two more widely-adopted conventional black frame insertion technologies respectively. Referring to FIG. 1A, the black frame insertion technology disclosed in FIG. 1A is achieved by a display data black insertion (DBI) technique, which transmits display data to black state signals DBI in a transmission frequency of 60 Hz and inserts a black frame into a certain region of an image by scanning. Thus, all the display data black insertions (DBI) are completed after N frames so that the processing time would be prolonged and the visual quality appearing to the human eyes is worse as well.

Referring to FIG. 1B, the black frame insertion technology disclosed in FIG. 1B is also a display data black insertion (DBI) technology, which transmits display data to a black state-signal DBI in a transmission frequency of 120 Hz. The transmission frequency of 120 Hz is adopted to perform the insertion of the black frames into the images because 120 Hz can be partitioned as one 60 Hz to display normal images and the other 60 Hz to perform the insertion of the black frames into a whole image. It can be known that compared with the technology of inserting the black frames into the images in the transmission frequency of 60 Hz, the processing time required by the technology of inserting the black frames into the images in the transmission frequency of 120 Hz is shortened and its visual quality appearing to the human eyes is better too.

Nevertheless, by using the technology of inserting the black frames into the images in the transmission frequency of 120 Hz, the charge time of the pixel circuit in the LCD panel is half of the charge time required by using the technology of inserting black frames into the images in the refresh frequency of 60 Hz. For this reason, the size of the TFT in the pixel circuit has to be enlarged so as to accelerate the charging of the pixel circuit in the LCD panel. Furthermore, some relevant techniques, such as providing scan signals simultaneously to the two ends of the scan lines respectively, are also required to reduce the affect of the RC loading on the scan lines in the LCD panel thereby increasing the production cost of TFT-LCD.

In addition, whether the transmission frequency of 60 Hz or 120 Hz is adopted to perform the insertion of the black frames into the images, only one frame can serve as a basic processing unit. Specifically, by using the technology of inserting the black frames into the images in the transmission frequency of 120 Hz, when the TFT-LCD is displaying brighter images, the flicker phenomenon tends to occur in the LCD panel (especially with white images). In this case, although users can mitigate the flicker phenomenon by increasing the refresh frequency of the driver IC, such as the source driver, in the TFT-LCD, the power consumption of the driver IC would be increased accordingly, such that not only is the life span of the driver IC shortened, but the whole power consumption of the TFT-LCD is increased as well.

### SUMMARY OF THE INVENTION

In view of the aforementioned, the present invention is directed to a pixel circuit and a driving method thereof. By adding one select line to the pixel circuit, when the pixel circuit is in a holding state, a select signal is provided to the select line to pull up the charging voltage level required by the pixel circuit. As a result, the effect of the insertion of the black frames into the images is completed during one frame period.

The invention is also directed to a liquid crystal display (LCD) panel and an LCD thereof, which employs the pixel circuit and the driving method thereof in the present invention to achieve the effect of the insertion of black frames into the images during one frame period, and further to resolve several shortcomings mentioned in the prior art.

The present invention provides a pixel circuit including a select line, an active device (such as a thin film transistor, TFT), a liquid crystal capacitor, a first storage capacitor and a second storage capacitor. A gate of the active device is electrically connected to a scan line, a first drain/source of the active device is electrically connected to a data line, and a second drain/source of the active device is electrically connected to a pixel electrode. Both the liquid crystal capacitor and the second storage capacitor are electrically connected between the pixel electrode and a common electrode. The first storage capacitor is electrically connected between the select line and the pixel electrode.

The present invention also provides an LCD panel including at least one data line, at least one scan line and at least one pixel circuit, wherein the pixel circuit includes a select line, an active device (such as a TFT), a liquid crystal capacitor, a first storage capacitor and a second storage capacitor. A gate of the active device is electrically connected to a scan line, a first drain/source of the active device is electrically connected to a data line, and a second drain/source of the active device is electrically connected to a pixel electrode. Both the liquid crystal capacitor and the second storage capacitor are electrically connected between the pixel electrode and a common electrode. The first storage capacitor is electrically connected between the select line and the pixel electrode.

The present invention also provides an LCD panel including at least one scan line, at least one first data line, at least one second data line, at least one first pixel circuit and at least one second pixel circuit. The first pixel circuit includes a first select line, a first active device (such as a TFT), a first liquid crystal capacitor, a first storage capacitor and a second storage capacitor. A gate of the active device is electrically connected to the scan line, a first drain/source of the first active device is electrically connected to the first data line, and a second drain/source of the first active device is electrically connected to a pixel electrode. Both the first liquid crystal capacitor and the second storage capacitor are electrically connected between the pixel electrode and a common electrode. The first storage capacitor is electrically connected between the first select line and the pixel electrode.

The second pixel circuit includes a second select line, a second active device (such as a TFT), a second liquid crystal capacitor, a third storage capacitor and a fourth storage capacitor. A gate of the second active device is electrically connected to the scan line, a first drain/source of the second active device is electrically connected to the second data line, and a second drain/source of the second active device is electrically connected to the pixel electrode. Both the second liquid crystal capacitor and the fourth storage capacitor are electrically connected between the pixel electrode and the common electrode. The third storage capacitor is electrically connected between the second select line and the pixel electrode.

The present invention also provides an LCD including a gate driver, a source driver and an LCD panel. The gate driver has at least one gate line for outputting a scan signal through the gate line according to a basic timing. The source driver has at least one source line for receiving an image data so as to output a data signal through the source line.

The LCD panel includes at least one data line for receiving the data signal, at least one scan line for receiving the scan signal and at least one pixel circuit, wherein the pixel circuit includes a select line, an active device (such as a TFT), a liquid crystal capacitor, a first storage capacitor and a second storage capacitor. A gate of the active device is electrically connected to the scan line, a first drain/source of the active device is electrically connected to the data line, and a second drain/source of the active device is electrically connected to a pixel electrode. Both the liquid crystal capacitor and the second storage capacitor are electrically connected between the pixel electrode and a common electrode. The first storage capacitor is electrically connected between the select line and the pixel electrode.

In an embodiment of the present invention, the LCD further includes a select signal generating unit for providing a select signal to the select line.

The present invention also provides an LCD including a gate driver, a source driver and an LCD panel. The gate driver has at least one gate line for outputting a scan signal through the gate line according to a basic timing. The source driver has at least one first source line and at least one second source line, and the source driver is used for receiving an image data to output a first data signal and a second data signal through the first source line and the second source line respectively.

The LCD panel includes at least one scan line for receiving the scan signal, at least one first data line for receiving the first data signal, at least one second data line for receiving the second data signal, at least one first pixel circuit and at least one second pixel circuit. The first pixel circuit includes a first select line, a first active device (such as a TFT), a first liquid crystal capacitor, a first storage capacitor and a second storage capacitor. A gate of the first active device is electrically connected to the scan line, a first drain/source of the first active device is electrically connected to the first data line, and a second drain/source of the first active device is electrically connected to a pixel electrode. Both the first liquid crystal capacitor and the second storage capacitor are electrically connected between the pixel electrode and a common electrode. The first storage capacitor is electrically connected between the first select line and the pixel electrode.

The second pixel circuit includes a second select line, a second active device (such as a TFT), a second liquid crystal capacitor a third storage capacitor and a fourth storage capacitor. A gate of the second active device is electrically connected to the scan line, a first drain/source of the second active device is electrically connected to the second data line, and a second drain/source of the second active device is electrically connected to the pixel electrode. Both the second liquid crystal capacitor and the fourth storage capacitor are electrically connected between the pixel electrode and the common electrode. The third storage capacitor is electrically connected between the second select line and the pixel electrode.

In an embodiment of the present invention, an LCD further includes a select signal generating unit for providing a first select signal and a second select signal to the first select line and the second select line respectively.

The present invention also provides a driving method of a pixel circuit disclosed by the present invention. The driving method is described as follows. First, when the pixel circuit is in the charging state, namely, when the gate of the active device receives a high-level scan signal, the pixel electrode receives a high-level data signal through the data line so as to charge the liquid crystal capacitor, the first storage capacitor and the second storage capacitor. Next, when the pixel circuit is in the holding state, namely, when the gate of the active device receives a low-level scan signal, a select signal is provided to the select line for pulling up a voltage level of the pixel electrode.

In the pixel circuit and the driving method thereof disclosed in the present invention, since a select line is added to the pixel circuit, a storage capacitor is formed between the select line and the pixel electrode. Accordingly, when the pixel circuit is in the holding state, a select signal is provided to the select line for pulling up a charging voltage level required by the pixel circuit and thereby completely inserting the black frames into the images during one frame period according to the law of conservation of electric charge.

In addition, since the pixel circuit disclosed in the present invention is applied in the LCD panel and the LCD thereof provided by the present invention, the LCD panel and the LCD thereof achieve all technical effects intended by the pixel circuit of the present invention, and the motion blur phenomenon mentioned in the prior art can also be prevented when the LCD is displaying rapid dynamic images and thereby improving the display quality of the LCD.

In order to make the aforementioned and other objects, features and advantages of the present invention more comprehensible, preferred embodiments accompanied with figures are described in detail below.

### BRIEF DESCRIPTION OF THE DRAWINGS

FIGS. 1A and 1B illustrate schematic views of two more widely-adopted conventional black frame insertion technologies respectively.

FIG. 2 is a block diagram illustrating a liquid crystal display (LCD) according to an embodiment of the present invention.

FIG. 3 illustrates a circuit diagram of a pixel circuit according to an embodiment of the present invention.

FIG. 4 is a flowchart illustrating a driving method of a pixel circuit according to an embodiment of the present invention.

FIG. 5 illustrates a simulation waveform diagram of driving a pixel circuit according to an embodiment of the present invention.

FIG. 6A illustrates a timing waveform diagram of a select line according to an embodiment of the present invention.

FIG. 6B illustrates a schematic view of inserting the black frames into the images according to FIG. 6A.

FIG. 7A illustrates a timing waveform diagram of a select line according to another embodiment of the present invention.

FIG. 7B illustrates a schematic view of inserting the black frames into the images according to FIG. 7A.

FIG. 8 is a block diagram illustrating an LCD according to another embodiment of the present invention.

FIG. 9 illustrates a circuit diagram of a portion of the pixel circuit in the pixel array of the LCD panel according to FIG. 8.

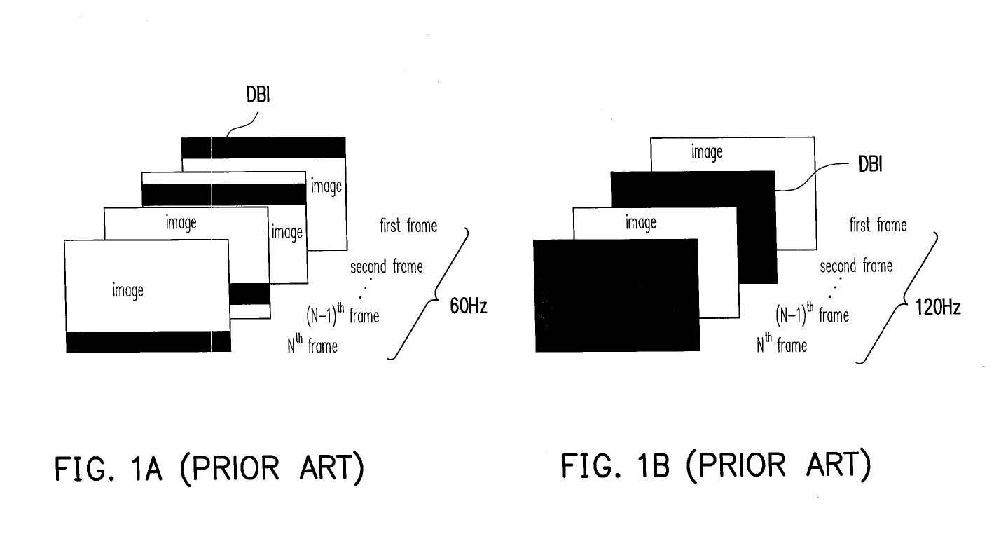

### DESCRIPTION OF EMBODIMENTS

The technical effect intended to be achieved in the present invention is to solve the conventional problem of motion blur occurring while the thin film transistor liquid crystal display (TFT-LCD) is playing rapid dynamic images. Several embodiments applying the normally white liquid crystals (LCs) are described in the following to illustrate in detail the technical feature and the intended effect of the present invention so as to serve as reference for those technicians skilled in the art of the invention.

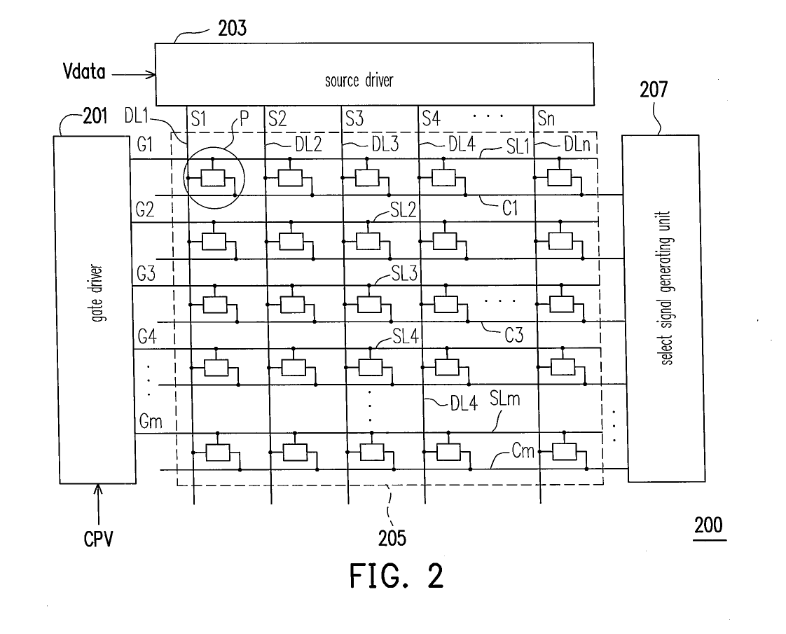

FIG. 2 is a block diagram illustrating an LCD 200 according to an embodiment of the present invention. Referring to FIG. 2, the LCD 200 (such as a TFT-LCD) includes a gate driver 201, a source driver 203, an LCD panel 205 and a select signal generating unit 207. The gate driver 201 has a plurality of gate lines G1-Gm for sequentially outputting the scan signals Vg through the gate lines G1-Gm to corresponding scan lines SL1-SLm in the LCD panel 205 according to a basic timing CPV provided by a timing controller (T-con, not illustrated).

The source driver 203 has a plurality of source lines S1-Sn for outputting the data signals Vd to corresponding data lines DL1-DLn in the LCD panel 205 through the source lines S1-Sn according to the image data Vdata provided by the T-con. The LCD panel 205 has a plurality of pixel circuits P. Each pixel circuit P correspondingly receives a scan signal Vg outputted by the gate driver 201 and is thus enabled and then each pixel circuit P charges according to corresponding data signals Vd outputted by the source driver 203.

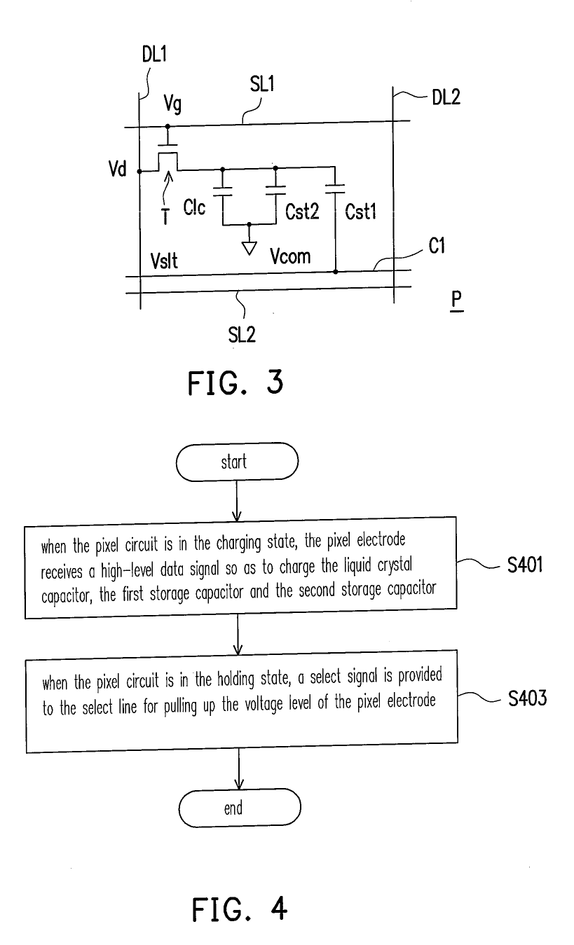

FIG. 3 illustrates a circuit diagram of the pixel circuit P according to an embodiment of the present invention. Referring to FIGS. 2 and 3, the pixel circuit P of the present embodiment includes a select line C, an active device T (such as a TFT), a liquid crystal capacitor Clc, a first storage capacitor Cst1 and a second storage capacitor Cst2. A gate of the active device T is electrically connected to a scan line SL, such as the scan line SL1, for receiving the scan signal Vg outputted by the gate driver 201 and is thus enabled. A drain of the active device T is electrically connected to the data line DL, such as the data line DL1, for receiving the data signal Vd outputted by the source driver 203 to charge the liquid crystal capacitor Clc, the first storage capacitor Cst1 and the second storage capacitor Cst2.

In the present embodiment, the liquid crystal capacitor Clc and the second storage capacitor Cst2 are formed between a pixel electrode (not illustrated) and a common electrode Vcom. The first storage capacitor Cst1 is formed between the pixel electrode and the select line C.

It should be mentioned that a structure of a pixel array in the LCD panel 205 is designed in the driving methods of the line inversion technique and the frame inversion technique. In order to better illustrate how the pixel circuit P of the present embodiment achieves the effect of the insertion of the black frames into the images, a driving method of the pixel circuit P is further described in the following with the normally white liquid crystals (LCs) so as to facilitate understanding of the present invention for those technicians skilled in the art. However, the present embodiment is not limited to using the normally white LCs in the pixel circuit P, which means that the pixel circuit P can also be driven with the normally black LCs.

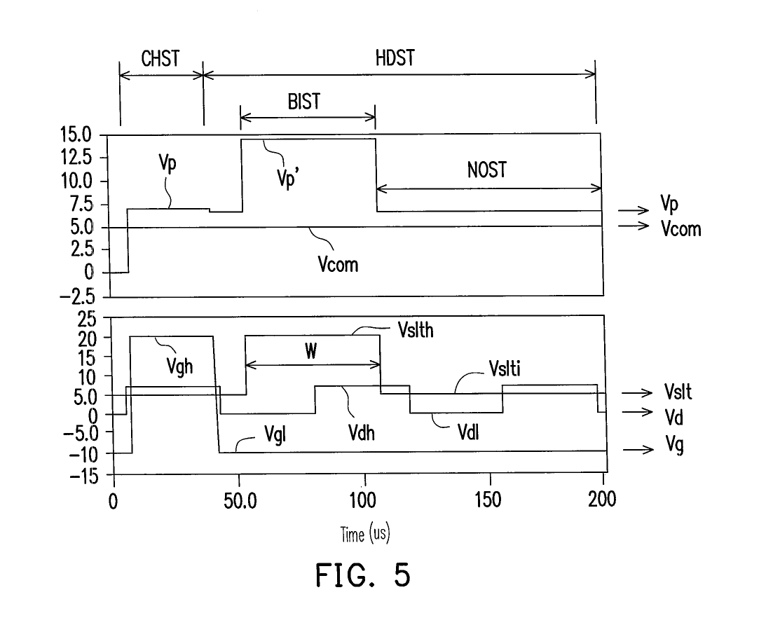

FIG. 4 is a flowchart illustrating a driving method of the pixel circuit P in the present embodiment. FIG. 5 illustrates a simulation waveform diagram of driving the pixel circuit P in the present embodiment, wherein the ordinate axis represents time us, and the abscissa axis represents voltage V. Referring to FIGS. 2-5, the driving method of the pixel circuit P in the present embodiment includes the following steps. First, as described in S401, when the pixel circuit P is in the charging state, the pixel electrode receives a high-level data signal Vdh through the data line DL1 to charge the liquid crystal capacitor Clc, the first storage capacitor Cst1 and the second storage capacitor Cst2. In this step S401, the charging state means when the gate of the active device T receives a high-level scan signal Vgh, the pixel circuit P will be in the charging state.

Next, as described in S403, when the pixel circuit P is in the holding state, the select signal generating unit 207 provides a select signal Vslt to the select line C, such as the select line C1, so as to pull up the voltage level Vp of the pixel electrode. In this step S403, the holding state means when the gate of the active device T receives a low-level scan signal Vg1, the pixel circuit P will be in the holding state.

Hence, according to the aforementioned and referring to FIGS. 2-5, it is known from the simulation waveform diagram disclosed in FIG. 5 that an overlapping area of the high-level scan signal Vgh and the high-level data signal Vdh is the charging state CHST. At the time, the pixel circuit P is in the charging state CHST, and the voltage Vp of the pixel electrode begins to charge the liquid crystal capacitor Clc, the first storage capacitor Cst1 and the second storage capacitor Cst2 because the data lines have outputted the high-level data signal Vdh.

Thereafter, when the scan signal Vg is asserted from the high-level scan signal to the low-level scan signal Vg1, the pixel circuit P will be in the holding state HDST. At the time, the select signal generating unit 207 provides a high-level select signal Vslth to the select line C1 and thus the voltage level of the voltage Vp of the pixel electrode is pulled up to a voltage level Vp′ for the coupling effect of the first storage capacitor Cst1, which is also the effect of the insertion of the black frames into the images BIST. When the select signal Vslt is asserted from the high-level select signal Vslth to the original voltage level select signal Vslti, the voltage level of the voltage Vp of the pixel electrode is pulled down to a voltage level before the pull-up. Consequently, the pixel circuit P is restored to a normal state NOST and waits for the next time when the scan signal Vg is asserted from the low-level scan signal Vgl to the high-level scan signal Vgh and then repeats the foregoing steps S401 and S403.

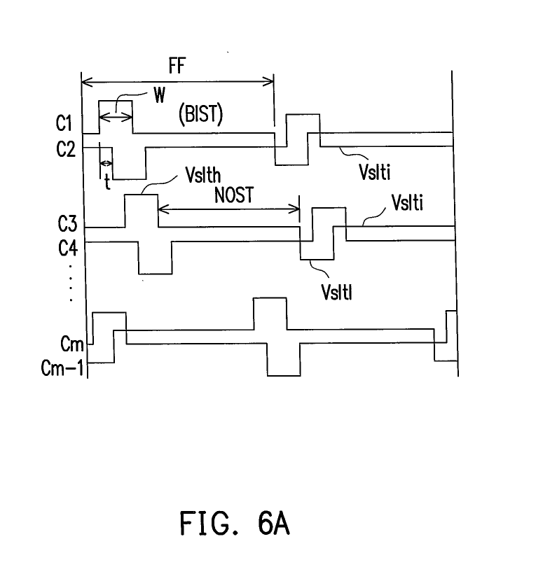

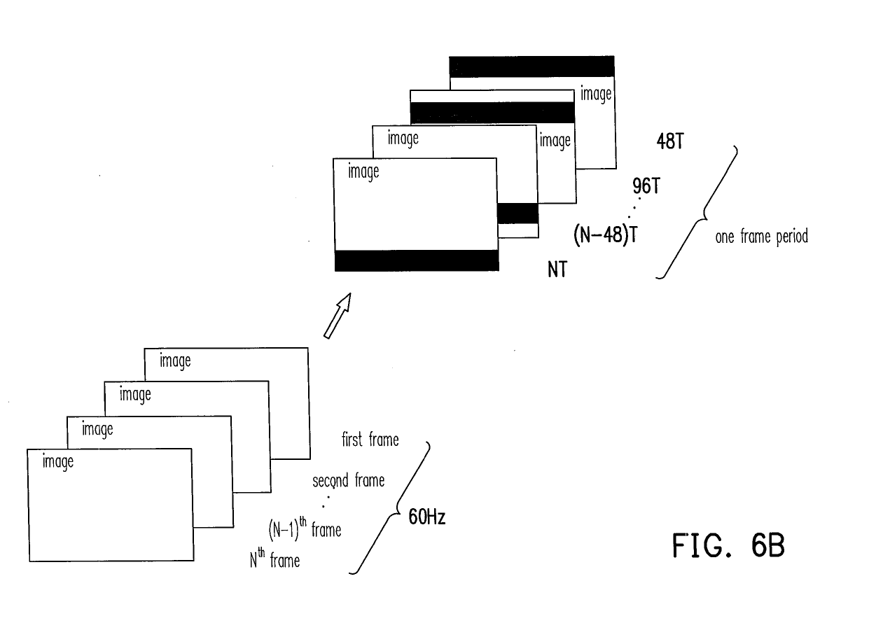

In addition, different width W of the duty cycle in the select signal Vslt outputted by the select signal generating unit 207 present different effects of the insertion of black frames into the images. FIG. 6A illustrates a timing waveform diagram of the select lines C1-Cm according to the present embodiment. FIG. 6B illustrates a schematic view of inserting the black frames into the images according to FIG. 6A. Referring to FIGS. 6A and 6B, during the first frame period FF, assuming the select lines of odd numbers C1, C3 . . . are receiving a high-level select signal Vslth, whereas the select lines of even numbers C2, C4 . . . are receiving a low-level select signal Vslt1. There is a time lapse t between the widths W of the duty cycles in every two select signals Vslt from the select lines C1-Cm. Accordingly, the widths W of the duty cycles in every two select signals Vslt from the select lines. C1-Cm have an overlapping area. Hence, inserting the black frames into the images (as illustrated in FIG. 6B) by scanning (in the transmission frequency of 60 Hz) during one frame period can be completed in the present embodiment, where “T” as illustrated in FIG. 6B represents the time allotted to each of the select lines C1-Cm under the total scan lines SL is 768, such as WXGA. For example, 48T represents the time spent passing through 48 select lines C1-C48.

Additionally, since the timing of inserting the black frames into the images is determined by the width W of the duty cycle in the select signal Vslt from each of the select lines C1-Cm, hence, adjusting the width W of the duty cycle in the select signal Vslt or changing the scanning direction of the insertion of the black frames into the images can achieve different effects of the insertion of the black frames into the images.

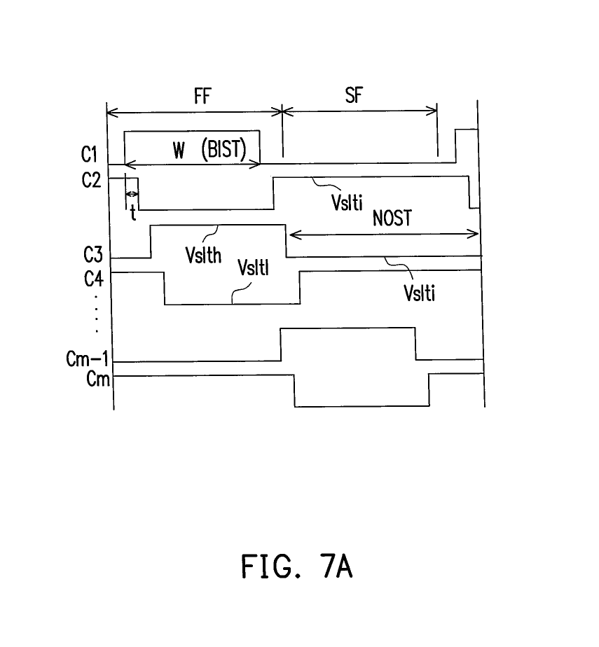

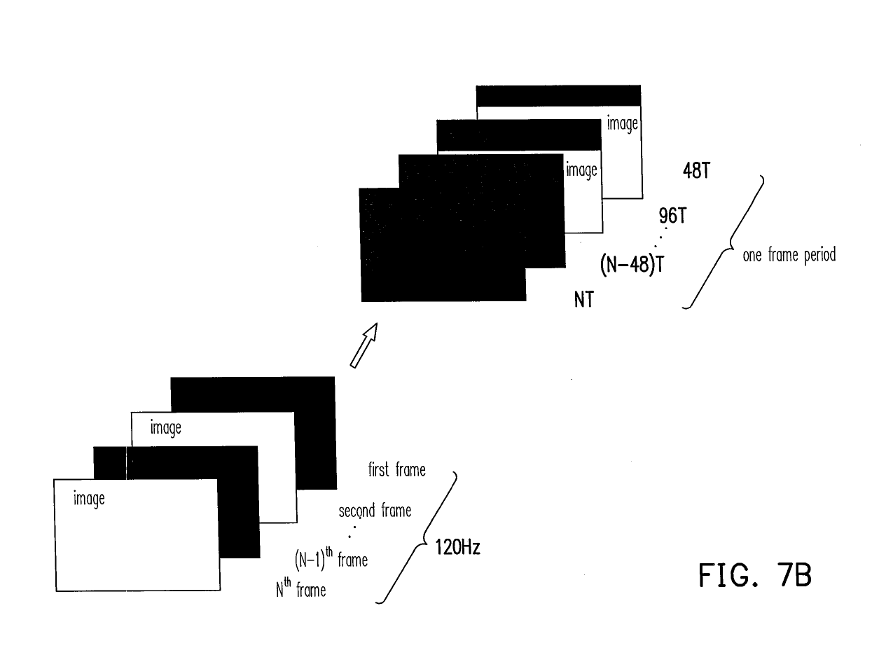

FIG. 7A illustrates a timing waveform diagram of the select lines C1-Cm according to another present invention. FIG. 7B illustrates a schematic view of inserting the black frames into the images according to FIG. 7A. Referring to FIGS. 7A and 7B, the width W of the duty cycle in the select signal Vslt from each of the select lines C1-Cm is increased as illustrated FIG. 7A so that the overlapping area where the insertion of the black frames into the images may cover all select lines C1-Cm and thereby completing the insertion of the black frames into the images during only one frame period (as illustrated in 7B). As a result, the transmission frequency is changed into 120 Hz so as to obtain an equal effect as achieved by the display data black insertion (DBI) technology in the transmission frequency of 120 Hz in the prior art.

In view of the aforementioned, when the insertion of the black frames into the images is performed in the present embodiment, it does not involve the driver IC, and thus the power consumption of the driver IC is not increased so that the life span thereof is not shortened, either.

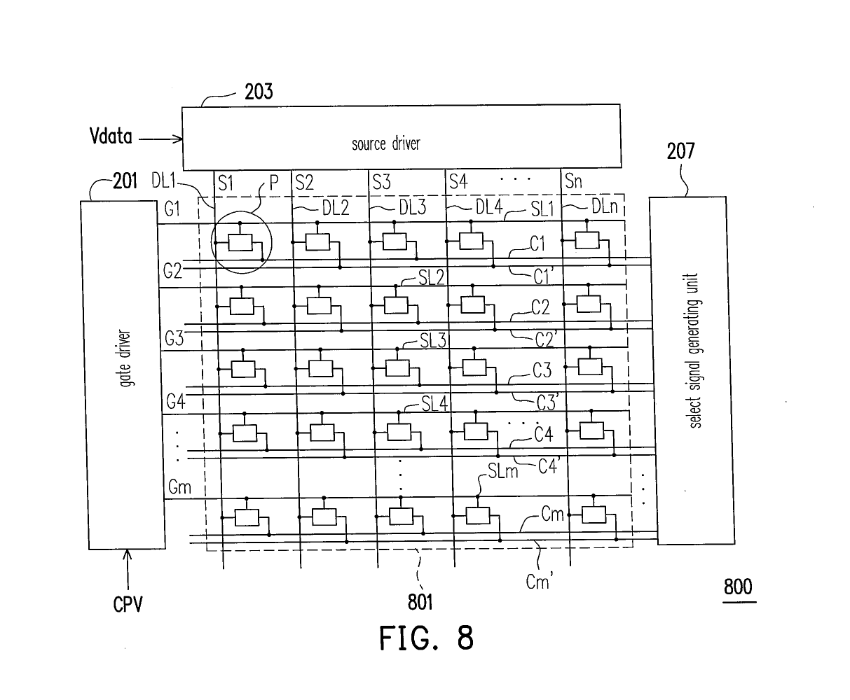

FIG. 8 is a block diagram illustrating an LCD 800 according to another present invention. Referring to FIGS. 2 and 8, the primary difference between the LCD 800 and the LCD 200 lies in that pixel array structures in an LCD panel 801 and the LCD panel 205 are different. The pixel array structure of the LCD panel 801 is designed in a driving method applying the dot inversion technique.

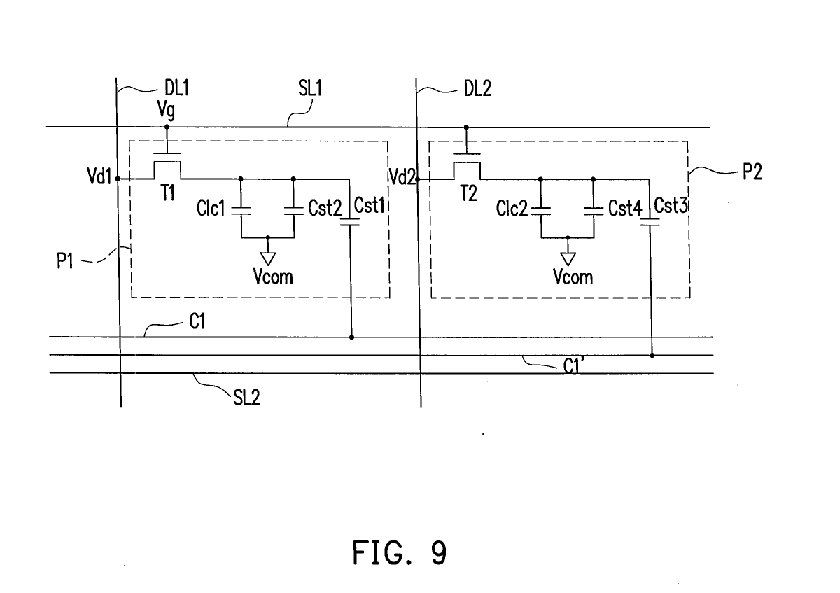

FIG. 9 illustrates a circuit diagram of a portion of the pixel circuit P in the pixel array of the LCD panel 801. Referring to both FIGS. 8 and 9, a pixel circuit P1 includes a select line C1, a first active device T1 (such as a TFT), a first liquid crystal capacitor Clc1, a first storage capacitor Cst1 and a second storage capacitor Cst2. A gate of the first active device T1 is electrically connected to a scan line SL, such as the scan line SL1, for receiving a scan signal Vg outputted by the gate driver 201 and is thus enabled. A drain of the first active device T1 is electrically connected to a data line DL, such as the data line DL1, for receiving a data signal Vd1 outputted by the source driver 203 to charge the first liquid crystal capacitor Clc1, the first storage capacitor Cst1 and the second storage capacitor Cst2.

A second pixel circuit P2 includes a select line C1′, a second active device T2 (such as a TFT), a second liquid crystal capacitor Clc2, a third storage capacitor Cst3 and a fourth storage capacitor Cst4. A gate of the second active device T2 is electrically connected to the scan line SL1 for receiving the scan signal Vg outputted by the gate driver 201 and is thus enabled. A drain of the second active device T2 is electrically connected to the data line DL2 for receiving a data signal Vd2 outputted by the source driver 203 to charge the second liquid crystal capacitor Clc2, the third storage capacitor Cst3 and the fourth storage capacitor Cst4.

In the present embodiment, the first liquid crystal capacitor Clc1, the second liquid crystal capacitor Clc2, the second storage capacitor Cst2 and the fourth storage capacitor Cst4 are formed between the pixel electrode (not illustrated) and the common electrode Vcom. The first storage capacitor Cst1 and the third storage capacitor Cst3 are formed respectively between the pixel electrode and the select line C1 and between the pixel electrode and the select line C1′.

Therefore, in view of the aforementioned, the pixel array of the LCD panel 801 requires adding select lines C1′-Cm′ to electrically connect to each of pixel circuits P of even numbers in each row of pixel circuits P in the LCD panel 801. The driving method of the LCD 800 with such pixel array structure is similar to that of the LCD 200. The spirit of achieving the image black insertion is described in the foregoing embodiments as well and is thus not to be reiterated herein.

In summary, the present invention provides a pixel circuit and the application thereof in the LCD panel and the LCD. In line with the spirit of the present invention, the invention has the following advantages.

Since a select line is added to the pixel circuit so as to form a storage capacitor between the select line and the pixel electrode, when the pixel circuit is thus in the holding state, according to the law of conservation of electric charge, a select signal is provided to the select line for pulling up a charging voltage level required by the pixel circuit and thereby inserting the black frames into the images during one frame period and presenting a better visual effect to the human eyes.

In the LCD panel and the LCD of the present invention, since the pixel circuit disclosed in the invention is applied to them, the pixel circuit achieves its intended technical effect, and the motion blur phenomenon mentioned in the prior art is also prevented when the LCD is displaying rapid dynamic images and thereby improving the display quality of the LCD without increasing the whole power consumption thereof.

Although the present invention has been disclosed above by the preferred embodiments, they are not intended to limit the present invention. Anybody skilled in the art can make some modifications and alterations without departing from the spirit and scope of the present invention. Therefore, the protecting range of the present invention falls in the app ended claims.

What is claimed is:

1. A pixel circuit, comprising:
a select line;
an active device, a gate of the active device electrically connected to a scan line, a first drain/source of the active device electrically connected to a data line, and a second drain/source of the active device electrically connected to a pixel electrode;
a liquid crystal capacitor, electrically connected between the pixel electrode and a common electrode; and
a first storage capacitor, electrically connected between the select line and the pixel electrode.

2. The pixel circuit as claimed in claim 1, further comprising a second storage capacitor, electrically connected between the pixel electrode and the common electrode.

3. The pixel circuit as claimed in claim 1, wherein the active device comprises a thin film transistor (TFT).

4. A liquid crystal display (LCD) panel, comprising:
at least one data line and at least one scan line; and
at least one pixel circuit, comprising:
a select line;
an active device, a gate of the active device electrically connected to the scan line, a first drain/source of the active device electrically connected to the data line, and a second drain/source of the active device electrically connected to a pixel electrode;
a liquid crystal capacitor, electrically connected between the pixel electrode and a common electrode; and
a first storage capacitor, electrically connected between the select line and the pixel electrode.

5. The LCD panel as claimed in claim 4, wherein the pixel circuit further comprises a second storage capacitor, electrically connected between the pixel electrode and the common electrode.

6. The LCD panel as claimed in claim 4, wherein the active device comprises a TFT.

7. An LCD panel, comprising:
at least one scan line;
at least one first data line and at least one second data line;
a first pixel circuit, comprising:
a first select line;
a first active device, a gate of the first active device electrically connected to the scan line, a first drain/source of the first active device electrically connected to the first data line, and a second drain/source of the first active device electrically connected to a pixel electrode;
a first liquid crystal capacitor, electrically connected between the pixel electrode and a common electrode; and
a first storage capacitor, electrically connected between the first select line and the pixel electrode; and
a second pixel circuit, comprising:
a second select line;
a second active device, a gate of the second active device electrically connected to the scan line, a first drain/source of the second active device electrically connected to the second data line, and a second drain/source of the second active device electrically connected to the pixel electrode;
a second liquid crystal capacitor, electrically connected between the pixel electrode and the common electrode; and
a third storage capacitor, electrically connected between the second select line and the pixel electrode.

8. The LCD panel as claimed in claim 7, wherein the first pixel circuit further comprises a second storage capacitor, electrically connected between the pixel electrode and the common electrode.

9. The LCD panel as claimed in claim 7, wherein the second pixel circuit further comprises a fourth storage capacitor, electrically connected between the pixel electrode and the common electrode.

10. The LCD panel as claimed in claim 7, wherein the first active device and the second active device comprise a TFT.

11. An LCD, comprising:
a gate driver, having at least one gate line, for outputting a scan signal through the gate line according to a basic timing;
a source driver, having at least one source line, for receiving an image data so as to output a data signal through the source line; and
an LCD panel, comprising:
at least one data line, electrically connected to the source line, for receiving the data signal;
at least one scan line, electrically connected to the gate line, for receiving the scan signal; and
at least one pixel circuit, comprising:
a select line;
an active device, a gate of the active device electrically connected to the scan line, a first drain/source of the active device electrically connected to the data line, and a second drain/source of the active device electrically connected to a pixel electrode;
a liquid crystal capacitor, electrically connected between the pixel electrode and a common electrode; and
a first storage capacitor, electrically connected between the select line and the pixel electrode.

12. The LCD as claimed in claim 11, further comprising a select signal generating unit, electrically connected to the select line for providing a select signal to the select line.

13. The LCD as claimed in claim 11, wherein the pixel circuit further comprises a second storage capacitor, electrically connected between the pixel electrode and the common electrode.

14. The LCD panel as claimed in claim 11, wherein the active device comprises a TFT.

15. An LCD, comprising:
a gate driver, having at least one gate line, for outputting a scan signal through the gate line according to a basic timing;
a source driver, having at least one first source line and at least one second source line, for receiving an image data so as to output a first data signal and a second data signal through the first source line and the second source line respectively; and
an LCD panel, comprising:
at least one scan line, electrically connected to the gate line, for receiving the scan signal;
at least one first data line, electrically connected to the first source line, for receiving the first data signal;
at least one second data line, electrically connected to the second source line, for receiving the second data signal;
at least one first pixel circuit, comprising:
a first select line;
a first active device, a gate of the first active device electrically connected to the scan line, a first drain/source of the first active device electrically connected to the first data line, and a second drain/source of the first active device electrically connected to a pixel electrode;
a first liquid crystal capacitor, electrically connected between the pixel electrode and a common electrode; and
a first storage capacitor, electrically connected between the first select line and the pixel electrode; and
at least one second pixel circuit, comprising:
a second select line;
a second active device, a gate of the second active device electrically connected to the scan line, a first drain/source of the second active device electrically connected to the second data line, and a second drain/source of the second active device electrically connected to the pixel electrode;
a second liquid crystal capacitor, electrically connected between the pixel electrode and the common electrode; and
a third storage capacitor, electrically connected between the second select line and the pixel electrode.

16. The LCD as claimed in claim 15, further comprising a select signal generating unit, electrically connected to the first select line and the second select line for providing a select signal to the first select line and the second select line respectively.

17. The LCD as claimed in claim 15, wherein the first pixel circuit further comprises a second storage capacitor, electrically connected between the pixel electrode and the common electrode.

18. The LCD as claimed in claim 15, wherein the second pixel circuit further comprises a fourth storage capacitor, electrically connected between the pixel electrode and the common electrode.

19. The LCD as claimed in claim 15, wherein the first active device and the second active device comprise a TFT.

20. A driving method of a pixel circuit as claimed in claim 2, comprising:
a high-level data signal being received by the pixel electrode through the data line so as to charge the liquid crystal capacitor, the first storage capacitor and the second storage capacitor when the pixel circuit is in a charging state; and
providing a select signal to the select line for pulling up the voltage level of the pixel electrode when the pixel circuit is in a holding state.

21. The driving method as claimed in claim 20, wherein when the gate of the active device receives a high-level scan signal, the pixel circuit is in the charging state.

22. The driving method as claimed in claim 20, wherein when the gate of the active device receives a low-level scan signal, the pixel circuit is in the holding state.
